(19) United States
(12) Patent Application Publication
(10) Pub. No.: US 2023/0278695 A1
(43) Pub. Date: Sep. 7, 2023

(54) SYSTEMS FOR COOLING A LEADING EDGE OF A HIGH SPEED VEHICLE

(71) Applicant: General Electric Company, Schenectady, NY (US)

(72) Inventors: Nicholas William Rathay, Rock City Falls, NY (US); Gregory Alexander Natsui, Schenectady, NY (US); Thomas Earl Dyson, Niskayuna, NY (US)

(21) Appl. No.: 17/688,085

(22) Filed: Mar. 7, 2022

(51) Int. Cl. B64C 1/38; B64C 30/00

(52) U.S. Cl. CPC B64C 1/38; B64C 30/00

(57) ABSTRACT

A leading edge assembly for a hypersonic vehicle is provided. The leading edge assembly includes an outer wall that tapers to a leading edge, the outer wall having a porous region at the leading edge; a coolant supply assembly in fluid communication with the porous region for selectively providing a flow of coolant through the porous region of the outer wall; and an insulation layer disposed between a portion of the coolant supply assembly and the outer wall, wherein the insulation layer is configured to reduce heat transfer between the coolant supply assembly and the outer wall.

### FEDERALLY SPONSORED RESEARCH

This invention was made with government support under contract number FA8650-20-C-7011 awarded by the Defense Advanced Research Projects Agency (DARPA). The government has certain rights in the invention.

### FIELD

The present subject matter relates generally to leading edge technologies for use in high speed vehicles, such as hypersonic aircraft.

### BACKGROUND

High speed vehicles often experience thermal management issues resulting from high heat load experienced during high speed operation, particularly at leading edges where the free stream air impinges on the vehicle. For example, in an application involving hypersonic aircrafts, the leading edges can include the nose, engine cowls, and the leading edges of wings and stabilizers. Particularly when these vehicles are operating in the hypersonic speed range (e.g., Mach 5 or greater), the leading edges may be subjected to very high heat load (e.g., 500-1500 W/cm²) as the incident airflow passes through a bow shock and comes to rest at the vehicle surface, converting the kinetic energy of the gas to internal energy and greatly increasing its temperature. Unmitigated exposure to such thermal loading can result in component degradation and/or failure.

Improvements in materials and manufacturing techniques have enabled hypersonic aircraft to operate at higher speeds and temperatures. Additional advancements in vehicle speed and duration of high speed flight times can be achieved through improvement in the cooling ability and high temperature durability of the leading edges of high speed vehicles.

Improvements to leading edge technologies and methods of cooling leading edges or hypersonic vehicles would be particularly beneficial.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a perspective view of a hypersonic vehicle in accordance with an exemplary embodiment of the present disclosure.

FIG. 2 is a close-up, cross-sectional, schematic view of a leading edge assembly of a hypersonic vehicle in accordance with an exemplary embodiment of the present disclosure, as seen along Line A-A in FIG. 1.

FIG. 3 is a cross-sectional, schematic view of a leading edge assembly of a hypersonic vehicle in accordance with an exemplary embodiment of the present disclosure, as seen along Line B-B in FIG. 2.

FIG. 4 is a cross-sectional, schematic view of a leading edge assembly of a hypersonic vehicle in accordance with another exemplary embodiment of the present disclosure.

FIG. 5 is a cross-sectional, schematic view of a leading edge assembly of a hypersonic vehicle in accordance with another exemplary embodiment of the present disclosure.

FIG. 6 is a cross-sectional, schematic view of a leading edge assembly of a hypersonic vehicle in accordance with another exemplary embodiment of the present disclosure.

FIG. 7 is a cross-sectional, schematic view of a leading edge assembly of a hypersonic vehicle in accordance with another exemplary embodiment of the present disclosure.

FIG. 8 is a cross-sectional, schematic view of a leading edge assembly of a hypersonic vehicle in accordance with another exemplary embodiment of the present disclosure.

FIG. 9 is a cross-sectional, schematic view of a leading edge assembly of a hypersonic vehicle in accordance with another exemplary embodiment of the present disclosure.

FIG. 10 is a cross-sectional, schematic view of a leading edge assembly of a hypersonic vehicle in accordance with another exemplary embodiment of the present disclosure.

FIG. 11 is a cross-sectional, schematic view of a leading edge assembly of a hypersonic vehicle in accordance with another exemplary embodiment of the present disclosure.

FIG. 12 is a cross-sectional, schematic view of a leading edge assembly of a hypersonic vehicle in accordance with another exemplary embodiment of the present disclosure.

FIG. 13 is a cross-sectional, schematic view of a leading edge assembly of a hypersonic vehicle in accordance with another exemplary embodiment of the present disclosure.

FIG. 14 is a cross-sectional, schematic view of a leading edge assembly of a hypersonic vehicle in accordance with another exemplary embodiment of the present disclosure.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The following description is provided to enable those skilled in the art to make and use the described embodiments contemplated for carrying out the disclosure. Various modifications, equivalents, variations, and alternatives, however, will remain readily apparent to those skilled in the art. Any and all such modifications, variations, equivalents, and alternatives are intended to fall within the scope of the present disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the disclosure as it is oriented in the drawing figures. However, it is to be understood that the disclosure may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

In general, aspects of the present subject matter are directed to leading edge assemblies for high speed aircraft or vehicles, such as hypersonic aircraft. As used herein, the term “hypersonic” refers generally to air speeds above Mach 5. However, it should be appreciated that aspects of the present subject matter are not limited only to hypersonic flight, but may instead apply to applications involving other high speed vehicles, projectiles, objects, etc., with flight Mach numbers of less than 5. The description of leading edge assemblies herein with respect to use on a hypersonic aircraft are only examples intended to facilitate the explanation of aspects of the present subject matter. The present subject matter is not limited to such exemplary embodiments and applications. In fact, in embodiments described herein, it is possible for the same aircraft to fly at hypersonic, supersonic, and/or subsonic speeds.

The present disclosure is generally related to cooling technologies and thermal management features that are used to cool portions of one or more parts of a hypersonic aircraft, such as the leading edges of the wings, nose, propulsion engines, or other parts of the hypersonic aircraft that experience large temperature gradients.

Furthermore, the present disclosure is generally related to leading edge assemblies for high speed aircraft or vehicles, such as hypersonic aircraft, that include features that protect a coolant supply from picking up heat as it travels to a leading edge of the leading edge assembly. For example, the cooling technologies and thermal management features of the present disclosure include features that protect a working fluid from picking up heat as the working fluid travels to the leading edge.

In an exemplary embodiment, a leading edge assembly of the present disclosure includes an insulating feature that is configured to reduce heat transfer between a coolant supply (e.g., a working fluid) and an outer wall of the leading edge assembly.

In another exemplary embodiment, a leading edge assembly of the present disclosure includes a heat rejection portion that is configured to transfer heat from a leading edge to a region aft of the leading edge assembly.

In another exemplary embodiment, a leading edge assembly of the present disclosure includes a second coolant supply (e.g., a second working fluid) that is configured to provide a protective barrier between a first coolant supply (e.g., a first working fluid) and an outer wall of the leading edge assembly.

The leading edge assemblies of the present disclosure are used to cool portions of one or more parts of a hypersonic aircraft, such as the leading edges of the wings, nose, propulsion engines, or other parts of the hypersonic aircraft that experience large temperature gradients. Furthermore, the resulting leading edge assemblies of the present disclosure provide ways to protect a working fluid from picking up extra heat as the working fluid travels to the leading edge.

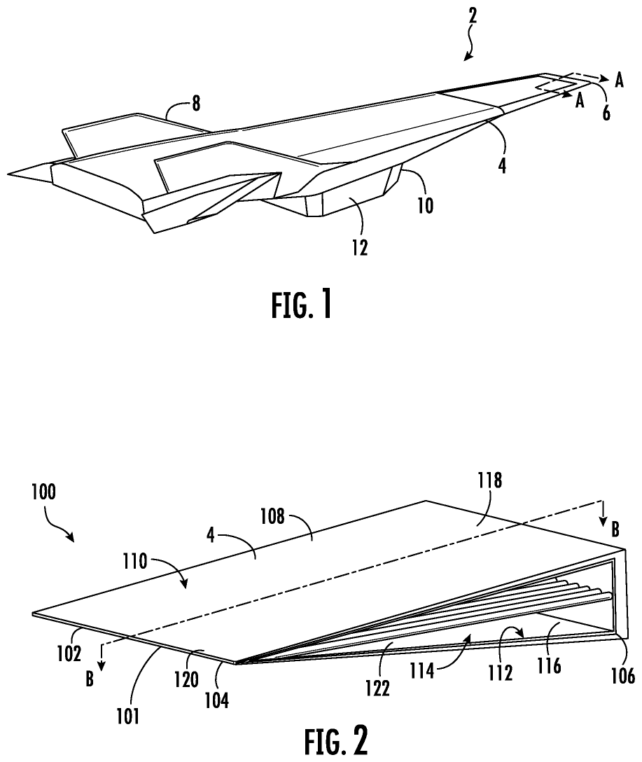

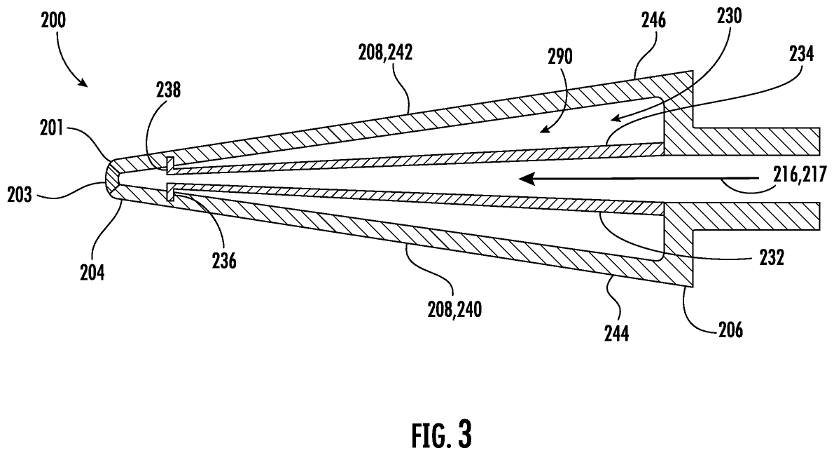

Referring to FIGS. 1 and 2, high speed vehicles, such as a hypersonic aircraft 2, typically experience extremely high temperatures and thermal gradients during high speed or hypersonic operation. The temperature gradients that are caused by the high heat flux are often a more severe problem than the temperature itself. For example, the thermal conductivity of the structural material, in combination with the heat flux, sets the temperature gradient within the material, and at high heat loads this gradient leads to mechanical stresses that cause plastic deformation or fracture of the material. The heat load to the structural material should be reduced to maintain the structural integrity of the components.

As will be appreciated, the leading edges of such high speed vehicles often experience the highest thermal loading. For example, a hypersonic vehicle may include a plurality of leading edge assemblies (e.g., identified generally herein by reference numeral 100) which experience high thermal loads during hypersonic flight. In this regard, leading edge assemblies 100 may be provided on a forward end of an aircraft wing 4, a nose 6, a vertical stabilizer 8, an engine cowl 10 of a propulsion engine 12, or other leading edges or surfaces of the hypersonic aircraft 2. According to exemplary embodiments of the present subject matter, leading edge assemblies 100 include features for mitigating the effects of such thermal loading, e.g., by carrying heat out of the region.

Notably, it is typically desirable to make leading edge assemblies 100 as sharp or pointed as possible, e.g., in order to reduce drag on the hypersonic vehicle. However, when leading edge assemblies 100 are formed into a sharp point, extremely high temperatures and thermal gradients are experienced within leading edge assembly 100 at its forward or leading edge 101, also referred to herein as a stagnation line, a stagnation point 102, or similar terms. In this regard, as a hypersonic vehicle is traveling through air at hypersonic speeds, a free stream flow of air passes over and around leading edge assembly 100, thereby generating large thermal loads. Aspects of the present subject matter are directed to cooling technologies and thermal management features that protect a working fluid from picking up heat as the working fluid travels to the leading edge 101.

It should be appreciated that the leading edge assemblies 100 illustrated herein are simplified cross section illustrations of exemplary leading edges described above. The size, configuration, geometry, and application of such leading edge technologies may vary while remaining within the scope of the present subject matter. For example, in exemplary embodiments, the leading edge assemblies 100 described herein define a radius of between about 1 mm and 3 mm. However, according to alternative embodiments, leading edge assemblies could have any other suitable diameter.

The cooling technologies and thermal management features are described herein as being used to cool portions of one or more parts of a hypersonic aircraft, such as the leading edges of the wings, nose, propulsion engines, or other parts of the hypersonic aircraft that experience large temperature gradients. However, it should be appreciated that aspects of the present subject matter may be used to manage thermal loading such as high temperatures and thermal gradients within any component and in any suitable application. In this regard, for example, aspects of the present subject matter may apply to any other hypersonic vehicle or to any other technology or system having components that are exposed to high temperatures and/or large temperature gradients.

In addition, although various techniques, component configurations, and systems are described herein for cooling leading edge assemblies 100 of a hypersonic vehicle, it should be appreciated that variations and modifications may be made to such technologies without departing from the scope of the present subject matter. In addition, one or more such technologies may be used in combination with each other to achieve improved cooling and thermal management. In this regard, although each cooling technology is described in isolation in order to clearly describe how each technology functions, the embodiments described are only examples intended for the purpose of illustration and explanation, and are not intended to limit the scope of the present subject matter in any manner.

In addition, according to exemplary embodiments of the present subject matter, some or all components described herein may be formed using an additive-manufacturing process, such as a 3-D printing process. The use of such a process may allow certain components of a hypersonic vehicle, such as leading edge assemblies 100, to be formed integrally, as a single monolithic component, or as any suitable number of sub-components. As used herein, the terms “additively manufactured” or “additive manufacturing techniques or processes” refer generally to manufacturing processes wherein successive layers of material(s) are provided on each other to “build-up,” layer-by-layer, a three-dimensional component. The successive layers generally fuse together to form a monolithic component which may have a variety of integral sub-components.

Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or manufacturing technology. For example, embodiments of the present disclosure may use layer-additive processes, layer-subtractive processes, or hybrid processes.

Suitable additive manufacturing techniques in accordance with the present disclosure include, for example, Fused Deposition Modeling (FDM), Selective Laser Sintering (SLS), 3D printing such as by inkjets, laser jets, and binder jets, Sterolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Selective Laser Melting (DSLM), Selective Laser Melting (SLM), Direct Metal Laser Melting (DMLM), and other known processes.

The additive manufacturing processes described herein may be used for forming components using any suitable material. For example, the material may be metal, concrete, ceramic, epoxy, or any other suitable material that may be in solid, liquid, powder, sheet material, wire, or any other suitable form or combinations thereof. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, and nickel or cobalt based superalloys (e.g., those available under the name Inconel® available from Special Metals Corporation). These materials are examples of materials suitable for use in the additive manufacturing processes described herein, and may be generally referred to as “additive materials.”

In addition, the additive manufacturing process disclosed herein allows a single component to be formed from multiple materials. Thus, the components described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

Referring to FIG. 2, leading edge assembly 100 will be described in more detail according to an exemplary embodiment of the present subject matter. Specifically, FIG. 2 provides a cross-sectional view of a leading edge assembly 100 of the aircraft nose 6 as seen along Line A-A in FIG. 1. However, it should be understood that the leading edge assembly 100 may be positioned at a leading edge (e.g., a forward end, a leading end, upstream end, etc.) of any component of a hypersonic aircraft. For example, leading edge assembly 100 may be, e.g., a leading edge of an inlet duct to a hypersonic propulsion engine, a leading edge of a ramj et/scramj et engine, a leading edge of a wing(let) of the aircraft, a forward end of a vertical stabilizer, etc.

As explained herein, large thermal loads may be experienced by leading edge assemblies 100 during hypersonic flight operations. As used herein, the terms “thermal load” and the like are intended generally to refer to the high temperatures, temperature gradients, or heat flux experienced within a component of a hypersonic or high-speed vehicle. According to exemplary embodiments of the present subject matter, leading edge assemblies 100 are formed or provided with thermal regulation features or technologies for managing these thermal loads.

For example, as described in more detail below with reference to FIG. 2, leading edge assembly 100 may include one or more features for providing or distributing a material within the leading edge assembly 100 to move thermal energy from one or more relatively hot locations, e.g., proximate the leading edge 101, to relatively cold regions, e.g., downstream of the leading edge 101. In this manner, the temperature experienced within leading edge assembly 100 may be reduced. It should be appreciated that the thermal regulation features and technologies described herein for each exemplary leading edge assembly 100 may be used alone or in combination with any other leading edge technologies described herein to regulate the thermal loading on one or more leading edge assemblies 100 of a hypersonic vehicle, or any other surface of any other component that experiences high thermal loading.

The leading edge 101 may define a forward end 104 of the leading edge assembly 100. The leading edge assembly 100 may further include an aft end 106. The leading edge 101 may define the leading edge of the nose 6 depicted in FIG. 1. The leading edge assembly 100 can include an outer wall 108. As explained above, outer wall 108 and other components of leading edge assembly 100 may be formed from any suitable material. According to an exemplary embodiment, such materials are selected to withstand the high thermal loading experienced by the leading edges of a hypersonic aircraft. For example, outer wall 108 may be constructed from at least one of aluminum, titanium, titanium aluminide, tungsten, tungsten alloys, nickel superalloys, refractory materials, high entropy refractory alloys, single-crystal metals, ceramic, ceramic matrix composites (CMC), or carbon-carbon composites. Nevertheless, it may still be desirable in certain applications to provide additional cooling for thermal management of the high heat loads experienced by leading edge assembly 100. Moreover, as explained above, the additive manufacturing technologies may be used to print leading edge assembly 100 (e.g., including outer wall 108) as a single monolithic component, and may facilitate improved cooling technologies and leading edge features. Leading edge assembly 100 may also be formed from traditional manufacturing methods, for example, sintering in a high temperature furnace or spark plasma sintering.

As is shown in the embodiment depicted, the outer wall 108 is generally formed from a continuous wall section. In other embodiments, the outer wall 108 can be formed from a first wall section and a second wall section that meet or join, for example, at the stagnation point 102. The surfaces of the outer wall 108 may be angled relative to each other such that leading edge assembly 100 is tapered from the aft end 106 of leading edge assembly 100 to the forward end 104 of leading edge assembly 100 (e.g., which corresponds to stagnation point 102). In other words, leading edge assembly 100 is wider or taller proximate aft end 106 of leading edge assembly 100 and narrows as it approaches stagnation point 102. Notably, the taper angle may vary depending on aerodynamic and other considerations while remaining within the scope of the present subject matter.

As described above, for the embodiment shown, the outer wall 108 generally forms a leading edge portion of the outer wall 108, and defines at least part of an outer surface 110 of the leading edge assembly 100 and an inner surface 112 of the leading edge assembly 100. It should be understood that the outer and inner surfaces 110 and 112 can be spaced apart from one another by a single-layered outer wall 108 or an outer wall including multiple discrete components, stratum, or the like. The outer wall 108 may generally define a cavity, or chamber 114, that is enclosed and defined by the inner surface 112. Thus, according to the exemplary embodiment, the chamber 114 may be an enclosed, constant volume chamber or reservoir. It is contemplated that the chamber 114 is a cavity that can contain any number of methods of insulating or increasing the thermal resistance between the external hot gas and the cooling fluid moving. According to an exemplary embodiment, the chamber 114 may be filled or charged with a working fluid 116 which is used to transfer thermal energy within leading edge assembly 100. In addition, outer wall 108 may be hermetically sealed or include impermeable walls.

Working fluid 116 can generally be any fluid or gas that circulates within chamber 114 to allow for transfer of thermal energy from relatively hot regions of the leading edge assembly 100 (e.g., proximate leading edge 101) to relatively cool regions of the leading edge assembly 100 (e.g., regions downstream from leading edge 101). Working fluid 116 should generally be selected such that it is compatible with leading edge assembly 100 and is suitable for the desired operating range. For example, according to exemplary embodiments, working fluid 116 may include at least one of water, steam, acetone, methanol, ethanol, toluene, etc. According to still other embodiments, the working fluid 116 can be a liquid metal. The working fluid 116 may include one or more of lithium, sodium, silver, etc.

According to an exemplary embodiment, chamber 114 generally extends between a condenser section 118 at one end of chamber 114 and an evaporator section 120 at an opposite end of chamber 114. Specifically, as illustrated, evaporator section 120 is positioned proximate forward end 104 of leading edge assembly 100, e.g., proximate leading edge 101, where the temperature and heat flux are typically the highest. By contrast, condenser section 118 may generally be positioned proximate aft end 106 of leading edge assembly 100, where temperatures are relatively low compared to the leading edge 101.

It should be appreciated that the terms “liquid” and “vapor” are used herein generally to refer to the phases or states of working fluid 116 as the working fluid passes within chamber 114. However, it should be appreciated that the present subject matter does not require that all working fluid 116 be a liquid, and vice versa, that all working fluid 116 be a vapor. Depending on the current operating conditions of leading edge assembly 100, working fluid 116 may be in any suitable state without departing from the scope of the present subject matter.

The leading edge assembly 100 may further include a capillary structure 122 that is positioned within chamber 114 for circulating working fluid 116. Specifically, as illustrated, capillary structure 122 can be positioned on the inner surface 112 of outer wall 108 within chamber 114. In this regard, capillary structure 122 may line or cover all or part of the perimeter of inner surface 112 for transporting condensed working fluid 116 toward the leading edge 101 of the leading edge assembly 100.

The capillary structure 122 may generally be any component, feature, material, or structure configured for to transporting liquid working fluid 116 from the condenser section 118 to the evaporator section 120 by capillary flow or forces. For example, capillary structure 122 may be a porous or mesh membrane. Alternatively, capillary structure 122 may be an array of capillary tubes, an offset wall, a porous structure, a wick, a screen, a honeycomb structure, or any other structure configured for urging a flow of liquid working fluid 116 toward evaporator section 120. In a particular embodiment, the capillary structure 122 includes a micro-porous structure or a micro-grooved structure that lines the inner surface 112 of the outer wall 108.

The cooling technologies and thermal management features are described herein as being used to cool portions of one or more parts of a hypersonic aircraft, such as the leading edges of the wings, nose, propulsion engines, or other parts of the hypersonic aircraft that experience large temperature gradients. Furthermore, the cooling technologies and thermal management features of the present disclosure provide ways to protect the working fluid 116 from picking up extra heat as the working fluid travels to the leading edge 101.

Referring now generally to FIGS. 3 through 10, in exemplary embodiments of the present disclosure, a leading edge assembly 200 including an insulating feature that is configured to reduce heat transfer between a coolant supply assembly 290 and an outer wall 208 of the leading edge assembly 200 will now be described. In exemplary embodiments, the coolant supply assembly 290 of the present disclosure includes conduits, ducts, chambers, or similar structure, e.g., chamber 114 (FIG. 2), that are able to enclose a flow of working fluid 216. It is contemplated that the coolant supply assembly 290 of the present disclosure may consist of a continuous channel or discrete rectangular, square, or circular channels. In exemplary embodiments, the discrete channels may have insulation layers disposed between them as described herein.

Referring to FIG. 3, a close-up, cross-sectional view of a portion of a leading edge assembly as seen along Line B-B in FIG. 2 is provided. The exemplary leading edge assembly 200 depicted in FIG. 3 may be configured in substantially the same manner as the exemplary leading edge assembly 100 described above with reference to FIG. 2.

In the exemplary embodiment depicted, the leading edge assembly 200 includes the outer wall 208, the coolant supply assembly 290 (including the working fluid 216), and an insulation layer 230. It is contemplated that the insulation layer 230 can be filled with air, a low conductivity gas, a vacuum, or other low thermal conductivity insulation materials, e.g., alumina, zirconia, etc. As described, the outer wall 208 tapers to a leading edge 201 and the outer wall 208 includes a porous region 203 at the leading edge 201. The working fluid 216 is in fluid communication with the porous region 203 for selectively providing a flow of coolant 217 through the porous region 203. The insulation layer 230 is disposed between a portion of the working fluid 216 and the outer wall 208 and the insulation layer 230 is configured to reduce heat transfer between the working fluid 216 and the outer wall 208. In this manner, the insulation layer 230 protects the working fluid 216 from picking up extra heat as the working fluid travels towards the leading edge 201.

Referring to FIG. 3, the outer wall 208 includes a first outer wall 240 and a second outer wall 242 opposite the first outer wall 240. In an exemplary embodiment, the first outer wall 240 is located at a windward side 244 and the second outer wall 242 is located at a leeward side 246.

Referring still to FIG. 3, in an exemplary embodiment, the coolant supply assembly 290 includes a first wall 232 and a second wall 234 that surround the working fluid 216. In a first exemplary embodiment, the first wall 232 extends from an aft end 206 towards a forward end 204. Furthermore, the first wall 232 includes a first flange portion 236 that connects the first wall 232 to the first outer wall 240 adjacent the forward end 204. The second wall 234 extends from the aft end 206 towards the forward end 204. Furthermore, the second wall 234 includes a second flange portion 238 that connects the second wall 234 to the second outer wall 242 adjacent the forward end 204. The first and second insulation walls 232, 234 extend to a location within about 0.06 inches of the forward-most point of the leading edge 201, and further extend from a location at least about 1.0 inch from the forward-most point of the leading edge 201 (e.g., from a location between about 0.06 and 1.0 inch from the forward-most point of the leading edge 201).

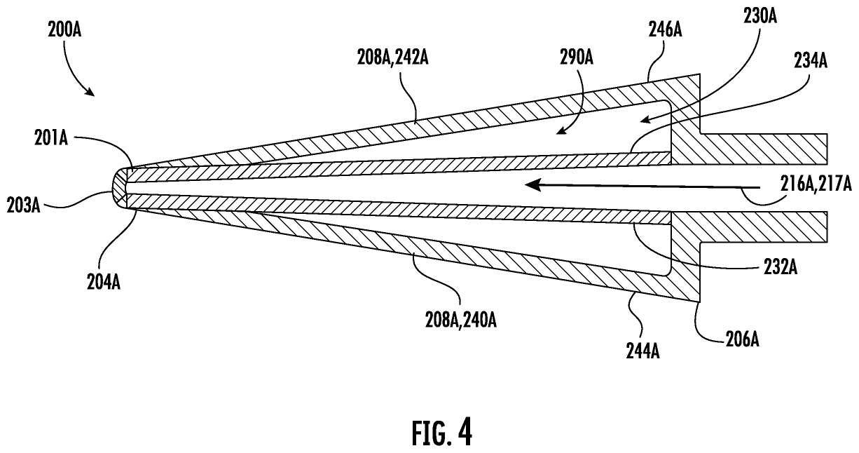

Referring now to FIG. 4, a close-up, cross-sectional view of a portion of a leading edge assembly as seen along Line B-B in FIG. 2 is provided. An exemplary leading edge assembly 200A depicted in FIG. 4 may be configured in substantially the same manner as the exemplary leading edge assembly 100 described above with reference to FIG. 2. The embodiment illustrated in FIG. 4 includes similar components to the embodiment illustrated in FIG. 3, and the similar components are denoted by a reference number followed by the letter A. For the sake of brevity, these similar components of leading edge assembly 200A (FIG. 4) will not all be discussed in conjunction with the embodiment illustrated in FIG. 4.

In the exemplary embodiment depicted, the coolant supply assembly 290A of the leading edge assembly 200A includes a first wall 232A that extends from an aft end 206A towards a forward end 204A. In this exemplary embodiment, the first wall 232A does not include a flange portion and extends all the way to the forward end 204A as shown in FIG. 4.

Furthermore, the coolant supply assembly 290A of the leading edge assembly 200A includes a second wall 234A that extends from the aft end 206A towards the forward end 204A. In this exemplary embodiment, the second wall 234A does not include a flange portion and extends all the way to the forward end 204A as shown in FIG. 4.

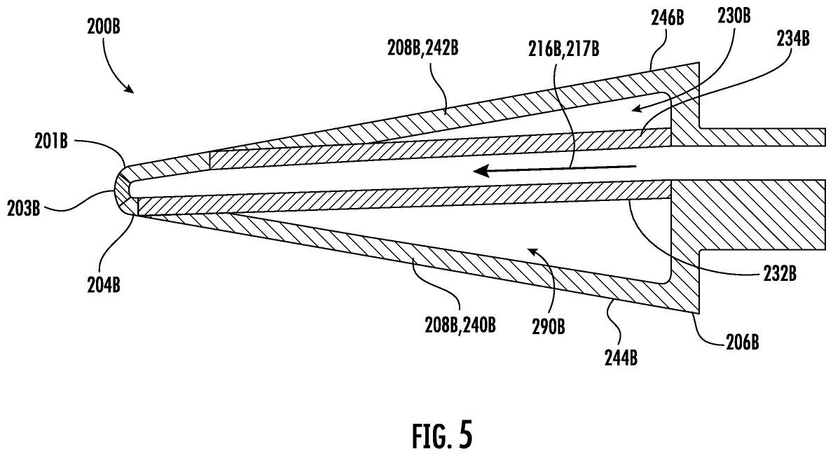

Referring now to FIG. 5, a close-up, cross-sectional view of a portion of a leading edge assembly as seen along Line B-B in FIG. 2 is provided. An exemplary leading edge assembly 200B depicted in FIG. 5 may be configured in substantially the same manner as the exemplary leading edge assembly 100 described above with reference to FIG. 2. The embodiment illustrated in FIG. 5 includes similar components to the embodiment illustrated in FIG. 3, and the similar components are denoted by a reference number followed by the letter B. For the sake of brevity, these similar components of leading edge assembly 200B (FIG. 5) will not all be discussed in conjunction with the embodiment illustrated in FIG. 5.

In the exemplary embodiment depicted, the leading edge assembly 200B includes a coolant supply assembly 290B having a first wall 232B and a second wall 234B that are disposed closer to a second outer wall 242B than a first outer wall 240B. In exemplary embodiments, it is contemplated that all portions of the second wall 234B are disposed approximately 0.01 inches to approximately 0.02 inches from the second outer wall 242B.

In exemplary embodiments of the present disclosure, the first outer wall 240B is located at a windward side 244B and the second outer wall 242B is located at a leeward side 246B. The coolant supply assembly 290B, i.e., the conduits, ducts, chambers, or similar structure, e.g., chamber 114 (FIG. 2), that are able to enclose a flow of working fluid 216B, as well as an insulation layer 230B, are disposed closer to the second outer wall 242B that is located farther away from the windward side 244B because the windward side 244B is the side that has the higher heat load region (in at least certain embodiments). In this manner, the insulation layer 230B is configured to further protect the working fluid 216B from picking up extra heat as the working fluid travels to a leading edge 201B.

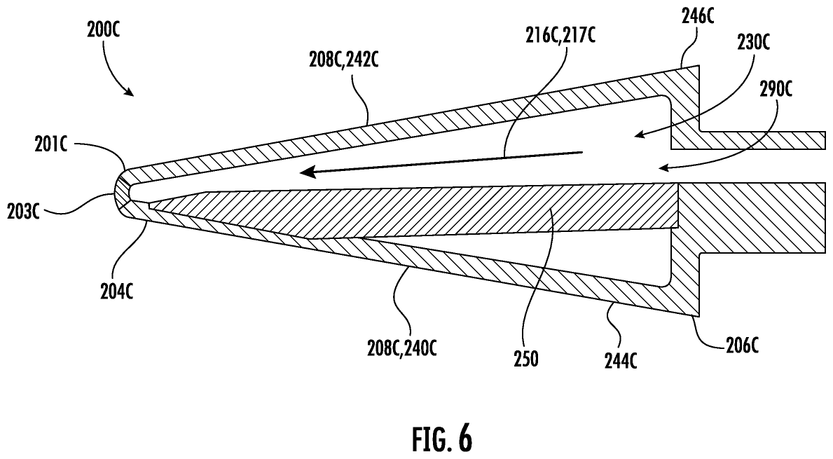

Referring now to FIG. 6, a close-up, cross-sectional view of a portion of a leading edge assembly as seen along Line B-B in FIG. 2 is provided. An exemplary leading edge assembly 200C depicted in FIG. 6 may be configured in substantially the same manner as the exemplary leading edge assembly 100 described above with reference to FIG. 2. The embodiment illustrated in FIG. 6 includes similar components to the embodiment illustrated in FIG. 3, and the similar components are denoted by a reference number followed by the letter C. For the sake of brevity, these similar components of leading edge assembly 200C (FIG. 6) will not all be discussed in conjunction with the embodiment illustrated in FIG. 6.

In the exemplary embodiment depicted, the leading edge assembly 200C includes an insulation layer 230C that is disposed between a portion of the coolant supply assembly 290C and an outer wall 208C. In the exemplary embodiment depicted, the coolant supply includes a single wall 250. The single wall 250 may have a thickness that is greater than a combined thickness of the first wall 232 (FIG. 3) and the second wall 234 (FIG. 3). In exemplary embodiments, it is contemplated that the single wall 250 may be approximately 0.01 inches thick to approximately 0.05 inches thick. In other exemplary embodiments, it is contemplated that the single wall 250 may be approximately 0.01 inches thick to approximately 0.5 inches thick. It is contemplated that the single wall 250 may have a variety of thicknesses to reduce a heat transfer between the working fluid 216C and the outer wall 208C for a particular application.

Furthermore, in the exemplary embodiment depicted, a flow of coolant 217C is located closer to a second outer wall 242C than the first outer wall 240C. In this manner, the flow of coolant 217C is located farther away from a windward side 244C because the windward side 244C is the side that has the higher heat load region.

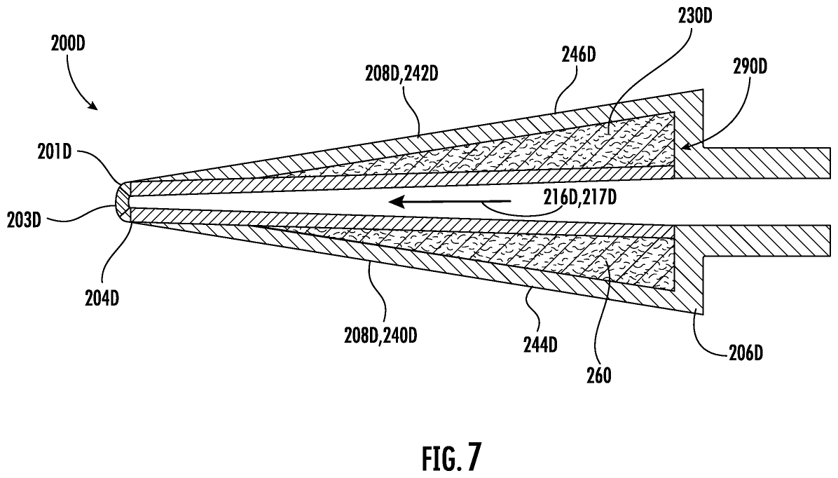

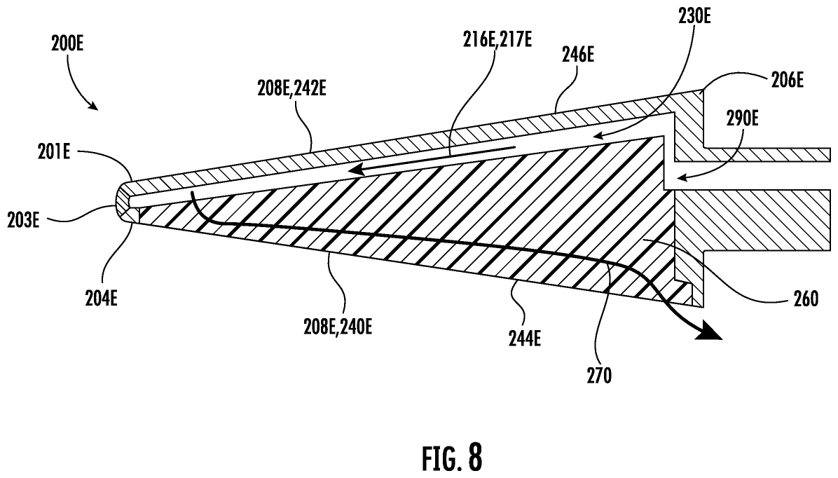

Referring now to FIG. 7, a close-up, cross-sectional view of a portion of a leading edge assembly as seen along Line B-B in FIG. 2 is provided. An exemplary leading edge assembly 200D depicted in FIG. 7 may be configured in substantially the same manner as the exemplary leading edge assembly 100 described above with reference to FIG. 2. The embodiment illustrated in FIG. 7 includes similar components to the embodiment illustrated in FIG. 3, and the similar components are denoted by a reference number followed by the letter D. For the sake of brevity, these similar components of leading edge assembly 200D (FIG. 7) will not all be discussed in conjunction with the embodiment illustrated in FIG. 7.

In the exemplary embodiment depicted, the leading edge assembly 200D includes an insulation layer 230D that is a solid insulating material 260 between a working fluid 216D and an outer wall 208D.

In an exemplary embodiment, the solid insulating material 260 is formed of a phase change material that is configured to change from a solid to a liquid or a liquid to a gas. Such a process absorbs heat energy as it changes phase. In an exemplary embodiment, the solid insulating material 260 is formed of a phase change material defining a phase change point between 100 degrees C. and 1500 degrees C. In another exemplary embodiment, the solid insulating material 260 is formed of a phase change material defining a phase change point between 100 degrees C. and 1400 degrees C. In yet another exemplary embodiment, the solid insulating material 260 is formed of a phase change material defining a phase change point between 100 degrees C. and 1300 degrees C. The solid insulating material 260 absorbs heat energy as it changes phase during high transient head loads.

In other exemplary embodiments, it is contemplated that the solid insulating material 260 may be formed of aerogel materials, ceramic materials, or other lower thermal conductivity materials.

Referring now to FIG. 8, a close-up, cross-sectional view of a portion of a leading edge assembly as seen along Line B-B in FIG. 2 is provided. An exemplary leading edge assembly 200E depicted in FIG. 8 may be configured in substantially the same manner as the exemplary leading edge assembly 100 described above with reference to FIG. 2. The embodiment illustrated in FIG. 8 includes similar components to the embodiment illustrated in FIG. 3, and the similar components are denoted by a reference number followed by the letter E. For the sake of brevity, these similar components of leading edge assembly 200E (FIG. 8) will not all be discussed in conjunction with the embodiment illustrated in FIG. 8.

In the exemplary embodiment depicted, the coolant supply assembly 290E of the leading edge assembly 200E includes a second coolant channel 270 that extends through a portion of the solid insulating material 260 and away from a leading edge 201E. The second coolant channel 270 is, in the embodiment depicted, in fluid communication with the coolant supply for receiving a portion of a flow of coolant 217E. In this manner, the flow of coolant 217E flows to a porous region 203E and is also able to flow through the second coolant channel 270 to cool the solid insulating material 260. In certain exemplary embodiments, the leading edge assembly 200E may be configured to provide between about 0.5% and about 25% of the flow of coolant 217E through the coolant supply assembly 290E to the second coolant channel 270. It is contemplated that the second coolant channel 270 may be printed in a monolithic silicon carbide (SiC) structure.

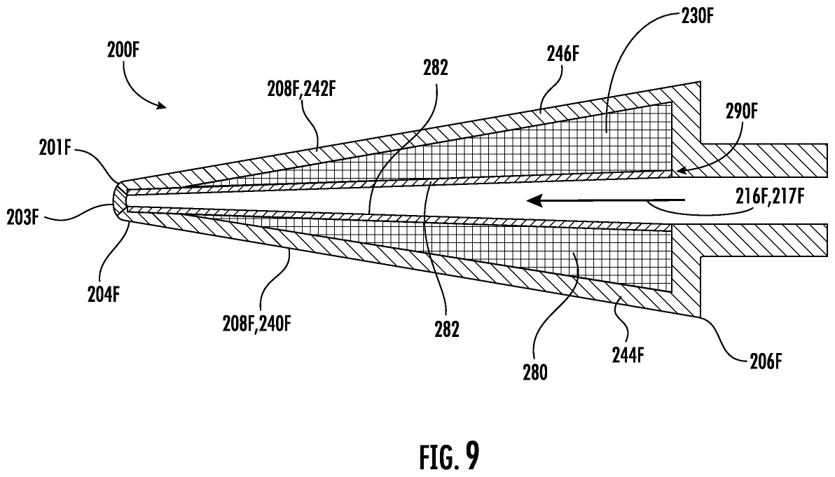

Referring now to FIG. 9, a close-up, cross-sectional view of a portion of a leading edge assembly as seen along Line B-B in FIG. 2 is provided. An exemplary leading edge assembly 200F depicted in FIG. 9 may be configured in substantially the same manner as the exemplary leading edge assembly 100 described above with reference to FIG. 2. The embodiment illustrated in FIG. 9 includes similar components to the embodiment illustrated in FIG. 3, and the similar components are denoted by a reference number followed by the letter F. For the sake of brevity, these similar components of leading edge assembly 200F (FIG. 9) will not all be discussed in conjunction with the embodiment illustrated in FIG. 9.

In the exemplary embodiment depicted, the leading edge assembly 200F includes an insulation layer 230F that is a porous lattice structure 280 between a working fluid 216F and an outer wall 208F. The porous lattice structure 280 may define a porosity between about 20% and about 95%, such as at least about 25%, such as at least about 45%, such as at least about 60%, such as at least about 75%, such as at least about 85%. Thermal conductivity is inversely related to porosity since heat will mainly conduct through the ligaments of the structure.

Furthermore, the leading edge assembly 200F includes a hermetic seal 282 that is located between the working fluid 216F and the porous lattice structure 280. In this manner, the hermetic seal 282 prevents the working fluid 216F from flowing into the porous lattice structure 280.

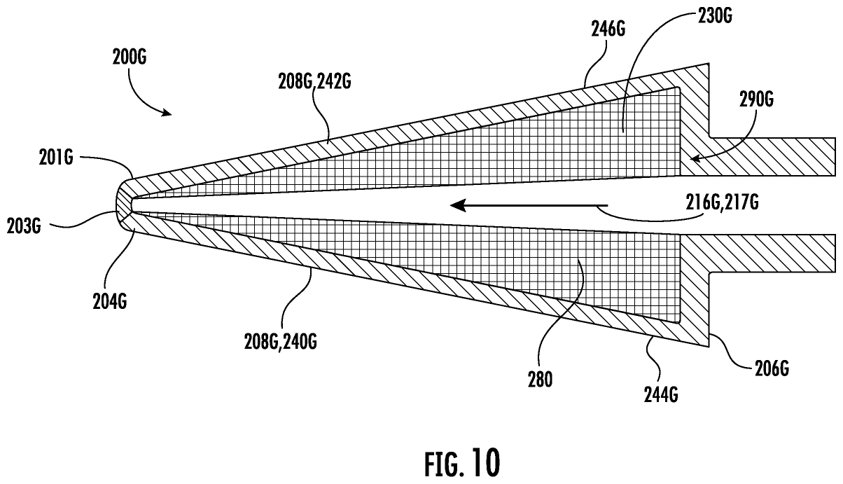

Referring now to FIG. 10, a close-up, cross-sectional view of a portion of a leading edge assembly as seen along Line B-B in FIG. 2 is provided. An exemplary leading edge assembly 200G depicted in FIG. 10 may be configured in substantially the same manner as the exemplary leading edge assembly 100 described above with reference to FIG. 2. The embodiment illustrated in FIG. 10 includes similar components to the embodiment illustrated in FIG. 3, and the similar components are denoted by a reference number followed by the letter G. For the sake of brevity, these similar components of leading edge assembly 200G (FIG. 10) will not all be discussed in conjunction with the embodiment illustrated in FIG. 10.

In the exemplary embodiment depicted, the leading edge assembly 200G includes an insulation layer 230G that is a porous lattice structure 280 between a working fluid 216G and an outer wall 208G. In this exemplary embodiment, the leading edge assembly 200G does not include a hermetic seal that is located between the working fluid 216G and the porous lattice structure 280. In this manner, the working fluid 216G is free to flow into the porous lattice structure 280. It is contemplated that the working fluid 216G is able to flow all the way through the porous lattice structure 280 and reach outer walls 240G, 242G. It is contemplated that a vast majority of the working fluid 216G would go to the leading edge 201G. A porous lattice structure 280 without hermetic seals may be easier to manufacture using conventional manufacturing methods. It is contemplated that such exemplary embodiments that are connected to a primary flow thereby eliminate pressurization of a closed cavity. It is further contemplated that such exemplary embodiments are highly tortuous to avoid creating fins that enhance transfer from the walls.

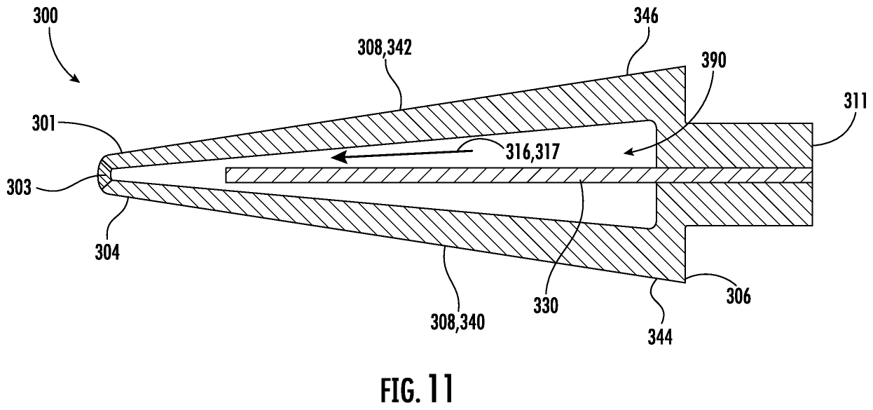

Referring now generally to FIGS. 11 through 13, in exemplary embodiments of the present disclosure, a leading edge assembly 300 including a heat rejection portion that is configured to transfer heat from a leading edge 301 to a region, e.g., an external surface of an aft region 311, aft of the leading edge assembly 300 will now be described.

Referring to FIG. 11, a close-up, cross-sectional view of a portion of a leading edge assembly as seen along Line B-B in FIG. 2 is provided. The exemplary leading edge assembly 300 depicted in FIG. 11 may be configured in substantially the same manner as the exemplary leading edge assembly 100 described above with reference to FIG. 2.

In the exemplary embodiment depicted, the leading edge assembly 300 includes an outer wall 308, a coolant supply assembly 390, and a heat pipe 330. In exemplary embodiments, the coolant supply assembly 390 of the present disclosure includes conduits, ducts, chambers, or similar structure (FIG. 2), that are able to enclose a flow of working fluid 316.

As described, the outer wall 308 tapers to the leading edge 301 and the outer wall 308 includes a porous region 303 at the leading edge 301. The working fluid 316 is in fluid communication with the porous region 303 for selectively providing a flow of coolant 317 through the porous region 303. The heat pipe 330 is disposed within a portion of the leading edge assembly 300 and is configured to transfer heat from the leading edge 301 to an aft region 311 downstream of the leading edge assembly 300. It is contemplated that the aft region 311 may include any portions aft of the leading edge assembly 300, including external surfaces aft of the leading edge assembly 300. In an exemplary embodiment, the heat pipe 330 extends from an aft end 306 towards a forward end 304.

Referring still to FIG. 11, the outer wall 308 includes a first outer wall 340 and a second outer wall 342 opposite the first outer wall 340. In an exemplary embodiment, the first outer wall 340 is located at a windward side 344 and the second outer wall 342 is located at a leeward side 346.

In an exemplary embodiment, the heat pipe 330 is disposed within a portion of the coolant supply, e.g., within a portion of the working fluid 316, within the outer wall 308 as shown in FIG. 11. The heat pipe 330 is configured to transfer heat from the leading edge 301 to the aft region 311 downstream of the leading edge assembly 300. In this manner, the heat can be transferred to such aft regions 311 downstream of the leading edge assembly 300. It is contemplated that, in some exemplary embodiments, the heat can be transferred to regions, e.g., external surfaces, further downstream of the leading edge assembly 300 and then may be rejected via radiation to the atmosphere. It is contemplated that the heat pipe 330 may include other heat transfer features such as area enhancing regions, heat transfer fins, or other heat transfer portions.

In an exemplary embodiment, the heat pipe 330 includes a phase change material that is configured to change from a solid to a liquid or a liquid to a gas. Such a process absorbs heat energy. In an exemplary embodiment, the heat pipe 330 is formed of a phase change material defining a phase change point between 100 degrees C. and 1500 degrees C. In another exemplary embodiment, the heat pipe 330 is formed of a phase change material defining a phase change point between 100 degrees C. and 1400 degrees C. In yet another exemplary embodiment, the heat pipe 330 is formed of a phase change material defining a phase change point between 100 degrees C. and 1300 degrees C.

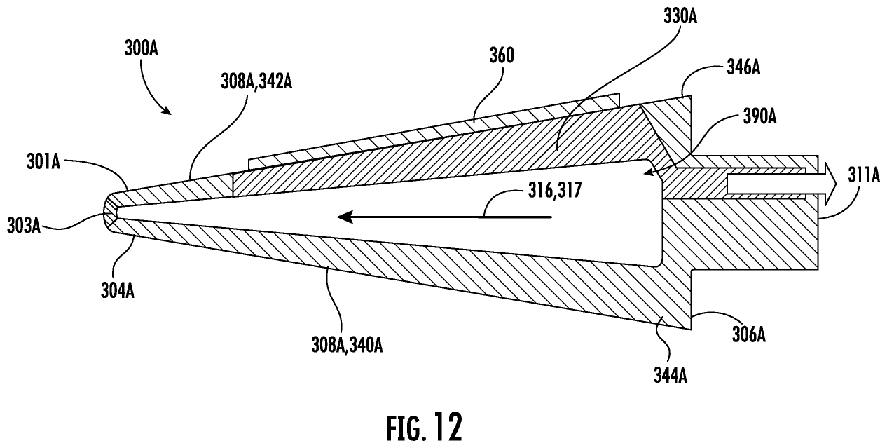

Referring now to FIG. 12, a close-up, cross-sectional view of a portion of a leading edge assembly as seen along Line B-B in FIG. 2 is provided. An exemplary leading edge assembly 300A depicted in FIG. 12 may be configured in substantially the same manner as the exemplary leading edge assembly 100 described above with reference to FIG. 2. The embodiment illustrated in FIG. 12 includes similar components to the embodiment illustrated in FIG. 11, and the similar components are denoted by a reference number followed by the letter A. For the sake of brevity, these similar components of leading edge assembly 300A (FIG. 12) will not all be discussed in conjunction with the embodiment illustrated in FIG. 12.

In the exemplary embodiment depicted, the leading edge assembly 300A includes a heat pipe 330A that is disposed within a portion of an outer wall 308A. For example, the heat pipe 330A is disposed within a portion of a second outer wall 342A. It is contemplated that the heat pipe 330A may also be disposed within a portion of a first outer wall 340A.

The heat pipe 330A is configured to transfer heat from a leading edge 301A to an aft region 311A downstream of the leading edge assembly 300A. It is contemplated that the heat pipe 330A may include other heat transfer features such as area enhancing regions, heat transfer fins, or other heat transfer portions

In exemplary embodiments, the leading edge assembly 300A includes a thermal barrier coating 360 that is disposed over a portion of the heat pipe 330A. It is contemplated that the thermal barrier coating 360 may be any high temperature capable materials with a low thermal conductivity, for example, a high temperature ceramic material or the like.

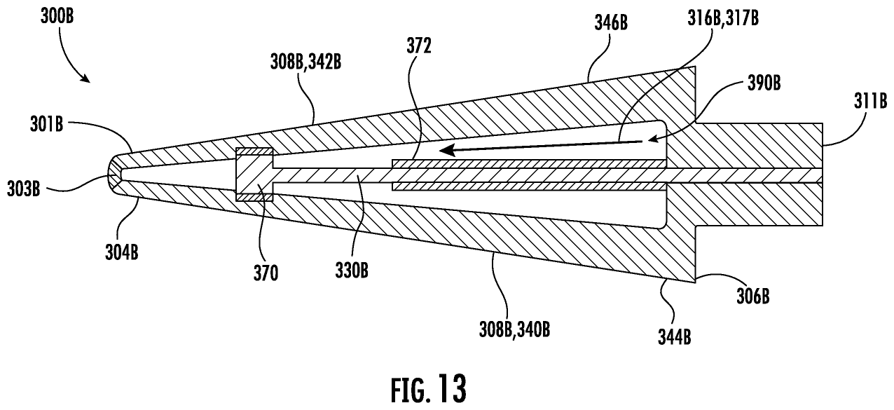

Referring now to FIG. 13, a close-up, cross-sectional view of a portion of a leading edge assembly as seen along Line B-B in FIG. 2 is provided. An exemplary leading edge assembly 300B depicted in FIG. 13 may be configured in substantially the same manner as the exemplary leading edge assembly 100 described above with reference to FIG. 2. The embodiment illustrated in FIG. 13 includes similar components to the embodiment illustrated in FIG. 11, and the similar components are denoted by a reference number followed by the letter B. For the sake of brevity, these similar components of leading edge assembly 300B (FIG. 13) will not all be discussed in conjunction with the embodiment illustrated in FIG. 13.

In the exemplary embodiment depicted, the leading edge assembly 300B includes a heat exchanger 370 and an insulation layer 372. The heat exchanger 370 is located between a heat pipe 330B and a leading edge 301B. In an exemplary embodiment, a flow of coolant 317B flows through the heat exchanger 370 and the heat exchanger 370 is configured to remove heat from the flow of coolant 317B and transfer the heat from the flow of coolant 317B to the heat pipe 330B. The heat pipe 330B then is able to transfer the heat away from the leading edge 301B to an aft region 311B downstream of the leading edge assembly 300B. Furthermore, the insulation layer 372 is disposed over a portion of the heat pipe 330B. For example, the insulation layer 372 may be disposed over the middle 50% of the heat pipe 330B, may be disposed over approximately 85% of the heat pipe 330B, may be disposed over approximately 90% of the heat pipe 330B, may be disposed over approximately 95% of the heat pipe 330B, or may be disposed over approximately 100% of the heat pipe 330B. It is also contemplated that an insulation layer surrounds the heat exchanger 370.

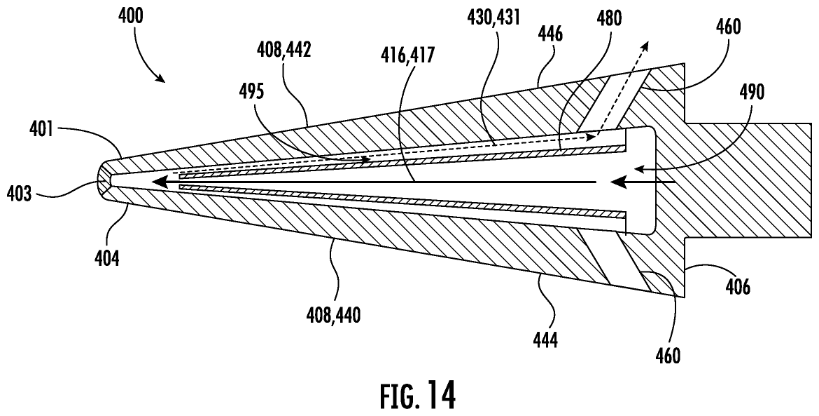

Referring now to FIG. 14, in another exemplary embodiment of the present disclosure, a leading edge assembly 400 including a second coolant supply assembly 495 that is configured to provide a protective barrier between a first coolant supply assembly 490 and an outer wall 408 of the leading edge assembly 400 will now be described.

Referring to FIG. 14, a close-up, cross-sectional view of a portion of a leading edge assembly as seen along Line B-B in FIG. 2 is provided. The exemplary leading edge assembly 400 depicted in FIG. 14 may be configured in substantially the same manner as the exemplary leading edge assembly 100 described above with reference to FIG. 2.

In the exemplary embodiment depicted, the leading edge assembly 400 includes the outer wall 408, the first coolant supply assembly 490, and the second coolant supply assembly 495. The first coolant supply assembly 490 includes conduits, ducts, chambers, or similar structure, e.g., chamber 114 (FIG. 2), that are able to enclose a flow of first working fluid 416. The second coolant supply assembly 495 includes conduits, ducts, chambers, or similar structure, e.g., chamber 114 (FIG. 2), that are able to enclose a flow of second working fluid 430.

As described, the outer wall 408 tapers to a leading edge 401 and the outer wall 408 includes a porous region 403 at the leading edge 401. In an exemplary embodiment, the outer wall 408 extends from an aft end 406 to a forward end 404. The outer wall 408 defines exit cooling openings 460. The first working fluid 416 is in fluid communication with the porous region 403 for selectively providing a first flow of coolant 417 through the porous region 403.

The second working fluid 430 is disposed between a portion of the first working fluid 416 and the outer wall 408 for selectively providing a second flow of coolant 431 therethrough. In this manner, the second working fluid 430 is configured to provide a protective barrier between the first working fluid 416 and the outer wall 408 that helps keep the first working fluid 416 cooler. In the exemplary embodiment depicted, the second flow of coolant 431 travels away from the leading edge 401 in an opposite direction of the first flow of coolant 417. Furthermore, the second flow of coolant 431 is ejected from the exit cooling openings 460. In exemplary embodiments, a separator wall 480 is also positioned between the first working fluid 416 and the second working fluid 430.

In exemplary embodiments, the first flow of coolant 417 and the second flow of coolant 431 are the same fluid. In other exemplary embodiments, the first flow of coolant 417 and the second flow of coolant 431 may be different fluids. It is contemplated that the second coolant supply including the second flow of coolant 431 may start approximately 0.06 inches from the leading edge 401 to approximately 1 inch from the leading edge 401.

Referring still to FIG. 14, the outer wall 408 includes a first outer wall 440 and a second outer wall 442 opposite the first outer wall 440. In an exemplary embodiment, the first outer wall 440 is located at a windward side 444 and the second outer wall 442 is located at a leeward side 446.

In other exemplary embodiments, it is contemplated that in-wall channels may be used to buffer a primary coolant flow resulting in low flow high coolant exit temperatures. In further exemplary embodiments, it is contemplated that splitter vanes may be used to bypass small amounts of flow to the wall regions. In this manner, the mixed temperature near the tip is reduced.

The present disclosure is generally related to cooling technologies and thermal management features that are used to cool portions of one or more parts of a hypersonic aircraft, such as the leading edges of the wings, nose, propulsion engines, or other parts of the hypersonic aircraft that experience large temperature gradients.

Furthermore, the present disclosure is generally related to leading edge assemblies for high speed aircraft or vehicles, such as hypersonic aircraft, that include features that protect a coolant supply from picking up heat as it travels to a leading edge of the leading edge assembly. For example, the cooling technologies and thermal management features of the present disclosure include features that protect a working fluid from picking up heat as the working fluid travels to the leading edge.

In an exemplary embodiment, a leading edge assembly of the present disclosure includes an insulating feature that is configured to reduce heat transfer between a coolant supply (e.g., a working fluid) and an outer wall of the leading edge assembly.

In another exemplary embodiment, a leading edge assembly of the present disclosure includes a heat rejection portion that is configured to transfer heat from a leading edge to a region aft of the leading edge assembly.

In another exemplary embodiment, a leading edge assembly of the present disclosure includes a second coolant supply (e.g., a second working fluid) that is configured to provide a protective barrier between a first coolant supply (e.g., a first working fluid) and an outer wall of the leading edge assembly.

The leading edge assemblies of the present disclosure are used to cool portions of one or more parts of a hypersonic aircraft, such as the leading edges of the wings, nose, propulsion engines, or other parts of the hypersonic aircraft that experience large temperature gradients. Furthermore, the resulting leading edge assemblies of the present disclosure provide ways to protect a working fluid from picking up extra heat as the working fluid travels to the leading edge.

Further aspects of the disclosure are provided by the subject matter of the following clauses:

A leading edge assembly for a hypersonic vehicle, the leading edge assembly comprising: an outer wall that tapers to a leading edge, the outer wall comprising a porous region at the leading edge; a coolant supply assembly in fluid communication with the porous region for selectively providing a flow of coolant through the porous region of the outer wall; and an insulation layer disposed between a portion of the coolant supply assembly and the outer wall, wherein the insulation layer is configured to reduce heat transfer between the coolant supply assembly and the outer wall.

The leading edge assembly of any preceding clause, wherein the coolant supply assembly comprises a first wall and a second wall that surround the flow of coolant.

The leading edge assembly of any preceding clause, wherein the outer wall comprises a first outer wall and a second outer wall opposite the first outer wall, wherein the first outer wall is located at a windward side, and wherein the second outer wall is located at a leeward side.

The leading edge assembly of any preceding clause, wherein the insulation layer is thicker at the windward side.

The leading edge assembly of any preceding clause, wherein the flow of coolant is closer to the second outer wall than the first outer wall.

The leading edge assembly of any preceding clause, wherein the insulation layer comprises a solid insulating material between the coolant supply assembly and the outer wall.

The leading edge assembly of any preceding clause, wherein the solid insulating material is formed of a phase change material defining a phase change point between 100 degrees C. and 1500 degrees C.

The leading edge assembly of any preceding clause, wherein the coolant supply assembly includes a coolant channel extending through a portion of the solid insulating material and away from the leading edge, wherein the coolant channel is in fluid communication with the flow of coolant.

The leading edge assembly of any preceding clause, wherein the insulation layer comprises a gas or a vacuum.

The leading edge assembly of any preceding clause, wherein the insulation layer comprises a porous lattice structure between the coolant supply assembly and the outer wall.

The leading edge assembly of any preceding clause, wherein the leading edge assembly includes a hermetic seal that is located between the coolant supply assembly and the porous lattice structure.

A leading edge assembly for a hypersonic vehicle, the leading edge assembly comprising: an outer wall that tapers to a leading edge, the outer wall comprising a porous region at the leading edge; a coolant supply assembly in fluid communication with the porous region for selectively providing a flow of coolant through the porous region of the outer wall; and a heat pipe disposed within a portion of the leading edge assembly, wherein the heat pipe is configured to transfer heat from the flow of coolant to a region aft of the leading edge assembly.

The leading edge assembly of any preceding clause, wherein the heat pipe is disposed within a portion of the coolant supply assembly.

The leading edge assembly of any preceding clause, wherein the heat pipe is disposed within a portion of the outer wall.

The leading edge assembly of any preceding clause, wherein a thermal barrier coating is disposed over a portion of the heat pipe.

The leading edge assembly of any preceding clause, further comprising a heat exchanger between the heat pipe and the leading edge, wherein the flow of coolant flows through the heat exchanger, and wherein the heat exchanger is configured to remove heat from the flow of coolant and transfer the heat from the flow of coolant to the heat pipe.

The leading edge assembly of any preceding clause, further comprising an insulation layer disposed over a portion of the heat pipe.

A leading edge assembly for a hypersonic vehicle, the leading edge assembly comprising: an outer wall that tapers to a leading edge, the outer wall comprising a porous region at the leading edge; a first coolant supply assembly in fluid communication with the porous region for selectively providing a first flow of coolant through the porous region of the outer wall; and a second coolant supply assembly disposed between a portion of the first coolant supply assembly and the outer wall for selectively providing a second flow of coolant therethrough, wherein the second coolant supply assembly is configured to provide a protective thermal barrier between the first coolant supply assembly and the outer wall.

The leading edge assembly of any preceding clause, wherein the second flow of coolant travels in an opposite direction of the first flow of coolant.

The leading edge assembly of any preceding clause, wherein the outer wall defines a cooling opening, and wherein the second flow of coolant is ejected from the cooling opening.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

While this disclosure has been described as having exemplary designs, the present disclosure can be further modified within the scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A leading edge assembly for a hypersonic vehicle, the leading edge assembly comprising:
an outer wall that tapers to a leading edge, the outer wall comprising a porous region at the leading edge;
a coolant supply assembly in fluid communication with the porous region for selectively providing a flow of coolant through the porous region of the outer wall; and
an insulation layer disposed between a portion of the coolant supply assembly and the outer wall, wherein the insulation layer is configured to reduce heat transfer between the coolant supply assembly and the outer wall.

2. The leading edge assembly of claim 1, wherein the coolant supply assembly comprises a first wall and a second wall that surround the flow of coolant.

3. The leading edge assembly of claim 1, wherein the outer wall comprises a first outer wall and a second outer wall opposite the first outer wall, wherein the first outer wall is located at a windward side, and wherein the second outer wall is located at a leeward side.

4. The leading edge assembly of claim 3, wherein the insulation layer is thicker at the windward side.

5. The leading edge assembly of claim 4, wherein the flow of coolant is closer to the second outer wall than the first outer wall.

6. The leading edge assembly of claim 1, wherein the insulation layer comprises a solid insulating material between the coolant supply assembly and the outer wall.

7. The leading edge assembly of claim 6, wherein the solid insulating material is formed of a phase change material defining a phase change point between 100 degrees C. and 1500 degrees C.

8. The leading edge assembly of claim 6, wherein the coolant supply assembly includes a coolant channel extending through a portion of the solid insulating material and away from the leading edge, wherein the coolant channel is in fluid communication with the flow of coolant.

9. The leading edge assembly of claim 1, wherein the insulation layer comprises a gas or a vacuum.

10. The leading edge assembly of claim 1, wherein the insulation layer comprises a porous lattice structure between the coolant supply assembly and the outer wall.

11. The leading edge assembly of claim 10, wherein the leading edge assembly includes a hermetic seal that is located between the coolant supply assembly and the porous lattice structure.

12. A leading edge assembly for a hypersonic vehicle, the leading edge assembly comprising:
an outer wall that tapers to a leading edge, the outer wall comprising a porous region at the leading edge;
a coolant supply assembly in fluid communication with the porous region for selectively providing a flow of coolant through the porous region of the outer wall; and
a heat pipe disposed within a portion of the leading edge assembly, wherein the heat pipe is configured to transfer heat from the flow of coolant to a region aft of the leading edge assembly.

13. The leading edge assembly of claim 12, wherein the heat pipe is disposed within a portion of the coolant supply assembly.

14. The leading edge assembly of claim 12, wherein the heat pipe is disposed within a portion of the outer wall.

15. The leading edge assembly of claim 14, wherein a thermal barrier coating is disposed over a portion of the heat pipe.

16. The leading edge assembly of claim 12, further comprising:
a heat exchanger between the heat pipe and the leading edge,
wherein the flow of coolant flows through the heat exchanger, and
wherein the heat exchanger is configured to remove heat from the flow of coolant and transfer the heat from the flow of coolant to the heat pipe.

17. The leading edge assembly of claim 16, further comprising:
an insulation layer disposed over a portion of the heat pipe.

18. A leading edge assembly for a hypersonic vehicle, the leading edge assembly comprising:
an outer wall that tapers to a leading edge, the outer wall comprising a porous region at the leading edge;
a first coolant supply assembly in fluid communication with the porous region for selectively providing a first flow of coolant through the porous region of the outer wall; and
a second coolant supply assembly disposed between a portion of the first coolant supply assembly and the outer wall for selectively providing a second flow of coolant therethrough, wherein the second coolant supply assembly is configured to provide a protective thermal barrier between the first coolant supply assembly and the outer wall.

19. The leading edge assembly of claim 18, wherein the second flow of coolant travels in an opposite direction of the first flow of coolant.

20. The leading edge assembly of claim 19, wherein the outer wall defines a cooling opening, and wherein the second flow of coolant is ejected from the cooling opening.
